(19) United States
(12) Patent Application Publication
(10) Pub. No.: US 2008/0156630 A1
(43) Pub. Date: Jul. 3, 2008

(54) Apparatus and Method for Producing Hydrogen Gas by Microwave Plasma Discharge

(75) Inventors: Bong-Ju Lee, Daejeon (KR); Yong-Ho Jung, Seoul (KR)

Correspondence Address: HOFFMANN & BARON, LLP, 6900 JERICHO TURNPIKE, SYOSSET, NY, 11791, US

(73) Assignees: KOREA BASIC SCIENCE INSTITUTE, Daejeon (KR); SEM TECHNOLOGY CO., LTD., Seoul (KR)

(21) Appl. No.: 11/914,586

(22) PCT Filed: May 16, 2006
(86) PCT No.: PCT/KR2006/001825

§ 371 Date: Nov. 16, 2007

(30) Foreign Application Priority Data
May 17, 2005 (KR) 10-2005-0041100

(51) Int. Cl. B01J 19/12

(52) U.S. Cl. 204/157.43; 422/186.04; 422/162

(57) ABSTRACT

The present invention relates to an apparatus and a method for producing hydrogen gas. The hydrogen gas production apparatus of the present invention comprises a) a dielectric hollow tube, b) a means for maintaining the dielectric hollow tube to a reduced pressure, c) a microwave source that generates a microwave, d) a waveguide coupled to the microwave source that applies the microwave to the dielectric hollow tube, e) a gas supply source that supplies a hydrogen element-containing gas into the dielectric hollow tube, wherein the hydrogen element-containing gas supplied into the dielectric hollow tube undergoes plasma discharge with aid of the microwave from the waveguide and produces reaction products including hydrogen gas through intramolecular bond breakage rather than heat decomposition, by collision of an electron produced by the plasma discharge with the hydrogen element-containing gas, and f) a separator that separates the hydrogen gas from the reaction products. The hydrogen gas production apparatus has a simple constitution and provides small scaled production of the hydrogen gas in a simple and efficient manner.

### TECHNICAL FIELD

The present invention relates to an apparatus and a method for the production of hydrogen gas.

### BACKGROUND ART

Plasmas have been widely used in various fields including semiconductor processes, surface treatment of materials, removal of hazardous gases, and formation of carbon nano-tube. For example, plasma produced by a microwave was used for the treatment of hazardous gases such as perfluorocarbon and hydrofluorocarbon (U.S. Pat. Nos. 5,965,786 and 6,290,918). In addition, U.S. Pat. No. 6,707,254 suggested a sterilizing method and a system through a microwave plasma discharge.

Hydrogen gases have been used in a field of chemical engineering such as desulphurization of crude oils, production of ammonia gases, and production of chemical fertilizers, in a field of food such as production of low fat margarines, in a field of metallurgy or steel manufacture such as heat treatment of metals, or as a fuel of vehicles or fuel cells. Recently, with the rapid growth of fuel cells and hydrogen vehicles, concern on a hydrogen gas production apparatus is being increased, which provides a small amount of the hydrogen gas at a point of the spot and in a continuous manner.

The hydrogen gases were mostly produced from reforming of natural gases or hydrocarbons. Besides, they were produced during naphtha reforming, coal gasification, electrolysis, and biomass. In the reforming processes, various reforming techniques were attempted such as steam reforming, oxygen reforming, or steam-oxygen mixed reforming. Commercially available was the steam reforming. The reformer used in the steam reforming comprises typically a steam generator, a desulphurization reactor, a reforming reactor and a water gas shift reactor. In general, the reformer has a bulky volume and a complicate configuration. Further, they have low thermal efficiency due to heat loss at pipes.

Further, the reforming reaction of the reformer is an endothermic reaction. Therefore, the reformer requires a heating source. As a heating source, burners, electrical heating sources or other heating sources are used. These exhibit low thermal efficiency. Particularly, when the burners such as a microwave torch are used as a heating source, most of exhaust heats are not recovered.

Further, even though the water gas shift reaction is somewhat exothermic, it requires preheating in order to initiate low temperature shift reaction. Currently, the water gas shift reaction requires preheating for about 2 hours. Therefore, the reformer is not applicable, as a hydrogen gas supply source, to the fuel cells or other apparatuses that require rapid operation.

### DISCLOSURE OF INVENTION

### Technical Problem

An object of the present invention is to provide an apparatus and a method for the efficient production of hydrogen gas.

Another object of the present invention is to provide an apparatus and a method for the production of hydrogen gas in a continuous manner through a microwave plasma discharge.

Further another object of the present invention is to provide an apparatus and a method for the production of hydrogen gas from a hydrogen element-containing gas through a bond cleavage between hydrogen element and an element bonded to the hydrogen element.

### Technical Solution

The objects and others which will be described in the detailed description of the specification can be accomplishable by provision of an apparatus for producing hydrogen gas by a microwave plasma discharge, comprising a) a dielectric hollow tube, b) a means for maintaining the dielectric hollow tube to a reduced pressure, c) a microwave source that generates a microwave, d) a waveguide coupled to the microwave source that applies the microwave to the dielectric hollow tube, e) a gas supply source that supplies a hydrogen element-containing gas into the dielectric hollow tube, wherein the hydrogen element-containing gas supplied into the dielectric hollow tube undergoes plasma discharge with aid of the microwave from the waveguide and produces reaction products including hydrogen gas through intramolecular bond breakage rather than heat decomposition, by collision of an electron produced by the plasma discharge with the hydrogen element-containing gas, and f) a separator that separates the hydrogen gas from the reaction products.

According to a preferred embodiment of the present invention, there is provided the apparatus for producing hydrogen gas wherein the dielectric hollow tube has a double tube configuration comprising an inner tube and an outer tube into which the inner tube is inserted.

According to another preferred embodiment of the present invention, there is provided the apparatus for producing hydrogen gas wherein the separator is a pressure swing adsorption concentrator.

According to further another preferred embodiment of the present invention, there is provided the apparatus for producing hydrogen gas wherein the hydrogen-element containing gas supplied from the gas supply source flows from a first end of the dielectric hollow tube to a second end of the dielectric hollow tube, and the waveguide is installed at a side of the dielectric hollow tube between the first and the second ends, and the separator is installed at the second end of the dielectric hollow tube.

According to more preferred embodiment of the present invention, there is provided the apparatus for producing hydrogen gas wherein the dielectric hollow tube has a longitudinal arrangement, and the hydrogen-element containing gas supplied from the gas supply source flows from a first end (a lower end) of the dielectric hollow tube to a second end (an upper end) of the dielectric hollow tube and at a position to which the waveguide is installed, the hydrogen-element containing gas undergoes a microwave plasma discharge to produce reaction products including hydrogen gas and the hydrogen gas is separated from the reaction products by the separator installed at the second end.

According to even more preferred embodiment of the present invention, there is provided the apparatus for producing hydrogen gas further comprising a solid element storage at the lower end of the dielectric hollow tube.

According to further another preferred embodiment of the present invention, there is provided the apparatus for producing hydrogen gas further comprising a vacuum chamber between the dielectric hollow tube and the separator, and to the vacuum chamber, the means for maintaining the dielectric hollow tube to a reduced pressure is connected.

According to further another preferred embodiment of the present invention, there is provided the apparatus for producing hydrogen gas wherein the hydrogen-element containing gas is selected from the group consisting of hydrocarbon, vaporized water and alcohol.

According to further another preferred embodiment of the present invention, there is provided a method for producing hydrogen gas, comprising a) maintaining an internal pressure of a dielectric hollow tube to a reduced pressure, b) flowing a hydrogen-element containing gas from a gas supply source through the dielectric hollow tube, c) subjecting the hydrogen-element containing gas to a microwave plasma discharge by applying a microwave to the dielectric hollow tube, d) producing reaction products including hydrogen gas through intramolecular bond cleavage by collision of an electron produced by the microwave plasma discharge with the hydrogen element-containing gas, and e) separating the hydrogen gas from the reaction products.

### ADVANTAGEOUS EFFECTS

The hydrogen gas production apparatus of the present invention has a simple constitution and produces small scaled hydrogen gas in a continuous manner. In addition to the hydrogen gas, solid carbon with high purity can be selectively recovered. Most of all, the apparatus of the present invention provides the hydrogen gas in a simple and effective manner. This enables the apparatus of the present invention to be applicable to fuel cells that require small amount of the hydrogen gas in a continuous manner.

### BRIEF DESCRIPTION OF THE DRAWINGS

FIG. 1 is a cross-sectional view showing a preferred embodiment of the hydrogen gas production apparatus, in accordance with the present invention.

FIG. 2 is a cross-sectional view showing another preferred embodiment of the hydrogen gas production apparatus, in accordance with the present invention, into which a solid element storage is additionally installed.

FIG. 3 is a cross-sectional view showing further another preferred embodiment of the hydrogen gas production apparatus, in accordance with the present invention, further comprising a vacuum chamber.

FIG. 4 is a cross-sectional view showing further another preferred embodiment of the hydrogen gas production apparatus, in accordance with the present invention, wherein a dielectric hollow tube has a double tube configuration.

### MODE FOR THE INVENTION

Hereinafter, the present invention will be more fully illustrated referring accompanied drawings.

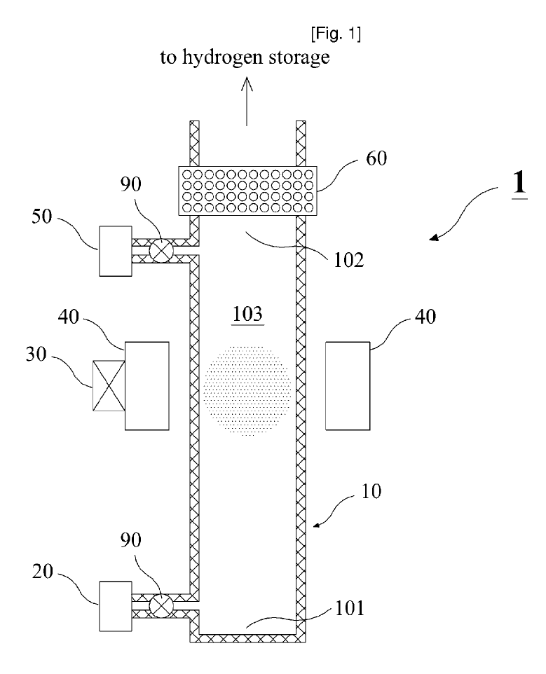

FIG. 1 is a cross-sectional view showing a preferred embodiment of the hydrogen gas production apparatus, in accordance with the present invention. As shown in FIG. 1, the apparatus 1 of the present invention is equipped with a dielectric hollow tube 10, a gas supply source 20, a microwave source 30, a waveguide 40 coupled to the microwave source 30, a decompressing means 50 and a separator 60.

Internal pressure of the dielectric hollow tube 10 is maintained to a reduced pressure by the decompressing means 50. As a decompressing means 50, a vacuum pump and a suction device can be mentioned.

From the gas supply source 20, a hydrogen-element containing gas is supplied into an internal space 103 of the dielectric hollow tube 10. As a hydrogen element-containing gas, a hydrocarbon, a vaporized water and an alcohol can be mentioned. As a hydrocarbon, methane, ethane, propane, and so on can be mentioned. Preferable is methane or vaporized water. The hydrogen-element containing gas can be supplied in a mixed form with an addictive gas (for example, an inert gas such as argon and helium) to increase discharge efficiency. With the provision of the hydrogen-element containing gas, the internal pressure of the dielectric hollow tube 10 is preferably maintained in a range of 500 Torr-30 Torr, more preferably, 300 Torr-50 Torr. Most preferably, it is in a range of 200-50 Torr. The hydrogen-element containing gas supplied into the internal space 103 of the dielectric hollow tube 10 flows from a first end 101 to a second end 102 of the dielectric hollow tube 10.

At a side of the dielectric hollow tube 10, the waveguide 40 coupled to the microwave source 30 is installed. The microwave source 30 generates a microwave. Preferable example of the microwave source 30 is a magnetron. The waveguide 40 applies the microwave generated from the microwave source 30 into the dielectric hollow tube 10. Preferably, the waveguide 40 comprises a tuner that tunes a power of the microwave from the microwave source 30, a taper that maximize output electric field of the microwave, a plunger that optimize the power absorbed into the hollow tube 10, and optionally a directional coupler that measures both output power from the microwave source 30 and input power to the tuner. Herein, the microwave applied into the dielectric hollow tube 10 has a power that induces intramolecular dissociation of the hydrogen-element containing gas. In other words, a power that results in an intramolecular bond breakage of the gas is applied into the dielectric hollow tube 10. The microwave has a frequency of 1 GHz-9 GHz. According to a specific example of the present invention, a microwave having a frequency of 2.45 GHz was used. At a microwave plasma discharge, an electron has an energy that induces intramolecular dissociation (or intramolecular bond breakage) by collision with the hydrogen-element containing gas. For example, methane undergoes intramolecular dissociation at 4.5 eV. Intramolecular dissociation of the vaporized water occurs at 4.8 eV. Therefore, the electron produced from the microwave plasma discharge has an energy sufficient for inducing intramolecular dissociation. Typically, the electron of the microwave plasma discharge has an energy of 4.5 eV-7 eV. Preferably, in case of methane, the electron preferably has an energy of 4.5 eV-6 eV and in case of vaporized water, of 4.8 eV-7 eV. In a meanwhile, the hydrogen gas production apparatus 1 of the present invention should not proceed to a torch type plasma discharge. In the torch type plasma discharge, the reaction progresses through thermal decomposition. This produces hydrogen gas at a very low efficiency, typically, of less than 1%.

The hydrogen element-containing gas moves through the internal space 103 to the second end 102 of the dielectric hollow tube 10 and undergoes a microwave plasma discharge at a position to which the waveguide 40 is installed. Specifically, with aid of the electric field from the waveguide 40, the hydrogen element-containing gas undergoes the microwave plasma discharge. By the microwave plasma discharge, the hydrogen element-containing gas produces, through an intramolecular bond breakage, reaction products including hydrogen gas. For example, suppose that the hydrogen element-containing gas is a hydrocarbon (for example, methane). In this case, the electron produced by the microwave plasma discharge collides with the hydrogen element-containing gas. During collision, an energy corresponding to vibration energy of the hydrogen element-containing gas may be delivered thereto. As a result, the hydrogen element-containing gas undergoes intramolecular dissociation (or intramolecular bond breakage). Intramolecular dissociation of the hydrocarbon gas produces hydrogen gas (H₂) and solid carbon as reaction products. If the gas to be used is vaporized water, hydrogen gas (H₂) and oxygen gas (O₂) are obtained as reaction products. In case of gaseous alcohol, hydrogen gas, oxygen gas and solid carbon are produced.

The reaction products including at least hydrogen gas are separated by a separator 60 installed at the second end 102 of the dielectric hollow tube 10. The separator 60 can be embodied in a diversified form. For example, in a case that solid element and hydrogen gas are produced as reaction products, a filter can act as the separator 60. Preferable example of the separator 60 is a pressure swing adsorption concentrator that discriminates gases using an affinity between a gas and a molecular sieve.

The hydrogen gas, discriminated and isolated from the residual products is stored into a hydrogen storage. If necessary, the hydrogen gas produced can be directly supplied to a fuel cell. Unexplained reference numeral 90 in FIG. 1 is a valve.

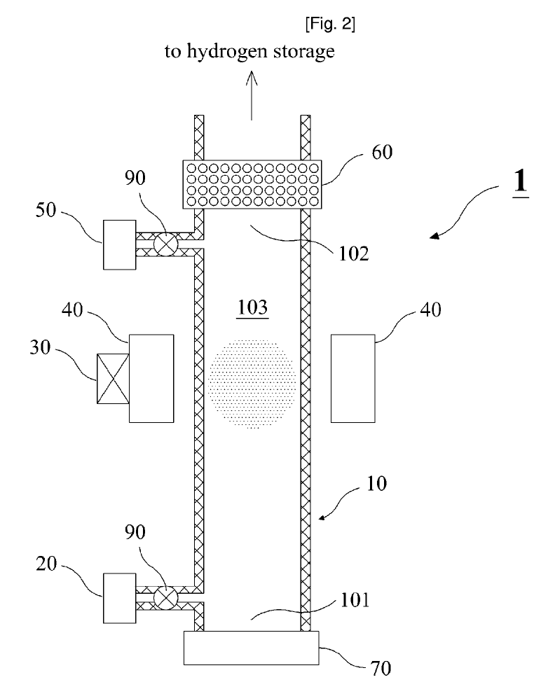

In FIG. 1, the dielectric hollow tube 10 has a longitudinal arrangement. Lateral arrangement may also be adopted. Preferable is the longitudinal arrangement. The longitudinal arrangement of the dielectric hollow tube 10 facilitates introduction of the hydrogen element-containing gas and separation of the hydrogen gas. Further, when solid carbon is produced as a reaction product, the longitudinal arrangement facilitates recovery of the solid carbon. More detailed explanation will be provided with reference to FIG. 2.

FIG. 2 is a cross-sectional view showing another preferred embodiment of the hydrogen gas production apparatus, in accordance with the present invention. As shown in FIG. 2, the hydrogen gas production apparatus 1 of the present invention further comprises a solid element storage 70 below the first end 101 of the dielectric hollow tube 10. The hydrogen gas production apparatus 1 shown in FIG. 2 is useful when the solid carbon, in combination with the hydrogen gas, is produced as a reaction product. Specifically, suppose that a hydrocarbon, preferably methane, is used as a hydrogen element-containing gas. In this case, hydrogen gas and solid carbon are produced as reaction products. The solid carbon produced will fall down due to gravity. The solid carbon has various applications. For example, the solid carbon with high purity is required for the manufacture of tires. Through the intramolecular bond breakage of methane, pure solid carbon is produced, in combination with the hydrogen gas. In order to recover the solid element, the solid element storage 70 is additionally installed. In FIG. 2, unexplained reference numerals are the same with those of FIG. 1.

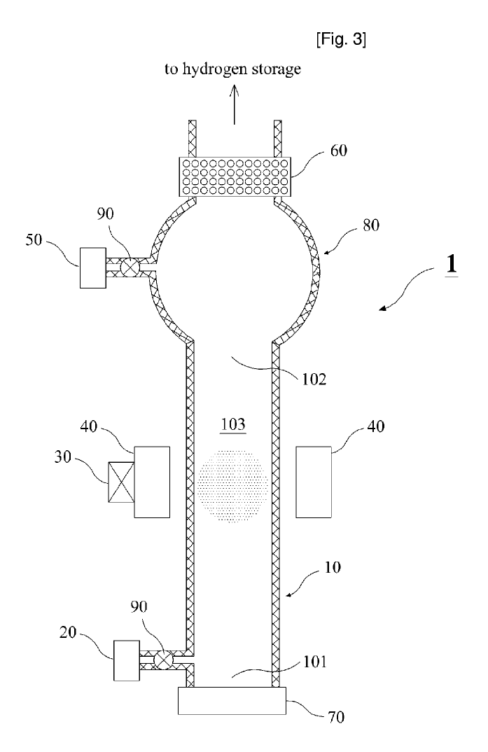

FIG. 3 is a cross-sectional view showing further another preferred embodiment of the hydrogen gas production apparatus, in accordance with the present invention. As shown in FIG. 3, the hydrogen gas production apparatus 1 of the present invention further comprises a vacuum chamber 80 between the dielectric hollow tube 10 and the separator 60. And, the decompressing means 50 is connected to the vacuum chamber 80. In the regulation of the internal pressure and production of solid carbon, the vacuum chamber 80 acts as a buffer zone. Specifically, in the regulation of the internal pressure of the dielectric hollow tube 10 using a decompressing means 50 such as a vacuum pump, narrow space of the dielectric hollow tube 10 causes sudden change of the internal pressure. This interrupts precise control of the internal pressure. Provision of an additional space by the vacuum chamber 80 assists the precise control of the internal pressure. Further, when the gas to be used is methane, the solid carbon, in combination with the hydrogen gas, is produced as a reaction product. Even though some of the solid carbon falls down, others will move upward due to upward flow of the hydrogen gas. Provision of an additional space by the vacuum chamber 80 diminishes the upward flow of the solid element. This facilitates separation of the hydrogen gas from the solid carbon and increase the amount of the solid carbon recovered. Unexplained reference numerals in FIG. 3 are the same with those of FIG. 2.

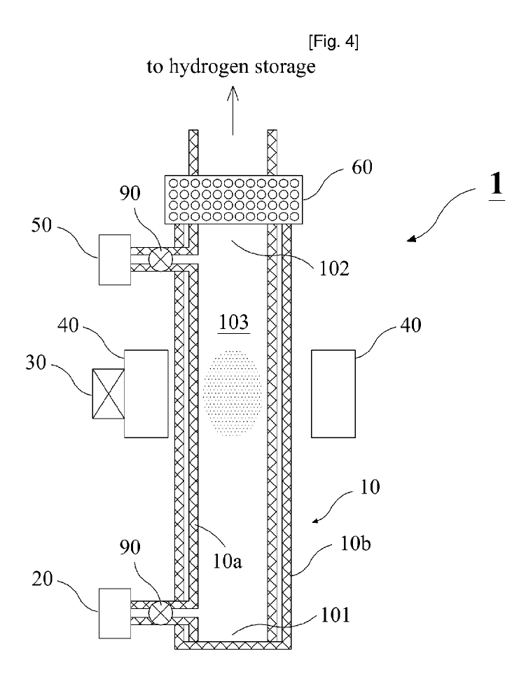

FIG. 4 is a cross-sectional view showing further another preferred embodiment of the hydrogen gas production apparatus, in accordance with the present invention. As shown in FIG. 4, the hydrogen gas production apparatus 1 of the present invention comprises a dielectric hollow tube 10 having a double tube configuration comprising an inner tube 10a and an outer tube 10b into which the inner tube 10a is inserted. Herein, the outer tube 10b protects the inner tube 10a through which the hydrogen element-containing gas is introduced. The microwave applied by the waveguide 40 sometimes causes damage to side wall of the dielectric hollow tube 10. It hinders stable working. The double tube configuration relievers such a danger. Unexplained reference numerals in FIG. 4 are the same with those of FIG. 1.

As described, it should be evident that the present invention can be implemented through a variety of configurations in the aforementioned technical field without affecting, influencing or changing its spirit and scope of the invention. Therefore, it is to be understood that the examples and applications illustrated herein is intended to be in the nature of description rather than of limitation. It should be clear that the scope of the present invention extends far beyond the specific descriptions mentioned above to encompass far more comprehensive range that will be continually defined by implementation and patent applications that will follow the present invention.

1. An apparatus for producing hydrogen gas by a microwave plasma discharge, comprising:
a) a dielectric hollow tube;
b) a means for maintaining the dielectric hollow tube to a reduced pressure;
c) a microwave source that generates a microwave;
d) a waveguide coupled to the microwave source that applies the microwave to the dielectric hollow tube;
e) a gas supply source that supplies a hydrogen element-containing gas into the dielectric hollow tube, wherein the hydrogen element-containing gas supplied into the dielectric hollow tube undergoes plasma discharge with aid of the microwave from the waveguide and produces reaction products including hydrogen gas through intramolecular bond breakage rather than heat de-composition, by collision of an electron produced by the microwave plasma discharge with the hydrogen element-containing gas; and
f) a separator that separates the hydrogen gas from the reaction products.

2. The apparatus as set forth in claim 1, wherein the dielectric hollow tube has a double tube configuration comprised of an inner tube and an outer tube into which the inner tube is inserted.

3. The apparatus as set forth in claim 1, wherein the separator is a pressure swing adsorption concentrator.

4. The apparatus as set forth in claim 1, wherein the hydrogen-element containing gas supplied from the gas supply source flows from a first end of the dielectric hollow tube to a second end of the dielectric hollow tube, and the waveguide is installed at a side of the dielectric hollow tube between the first and the second ends, and the separator is installed at the second end of the dielectric hollow tube.

5. The apparatus as set forth in claim 1, wherein the dielectric hollow tube has a longitudinal arrangement, and the hydrogen-element containing gas supplied from the gas supply source flows from a first end of the dielectric hollow tube to a second end of the dielectric hollow tube and at a position to which the waveguide is installed, the hydrogen-element containing gas undergoes a microwave plasma discharge to produce reaction products including hydrogen gas and the hydrogen gas is separated from the reaction products by the separator installed at the second end.

6. The apparatus as set forth in claim 5, further comprising a solid element storage at the first end of the dielectric hollow tube.

7. The apparatus as set forth in claim 1, further comprising a vacuum chamber between the dielectric hollow tube and the separator, and to the vacuum chamber, the means for maintaining the dielectric hollow tube to a reduced pressure is connected.

8. The apparatus as set forth in claim 1, wherein the hydrogen-element containing gas is selected from the group consisting of hydrocarbon, vaporized water and alcohol.

9. The apparatus as set forth in claim 8, wherein the hydrogen-element containing gas is vaporized water or methane.

10. The apparatus as set forth in claim 1, wherein the electron produced by the microwave plasma discharge has an energy of 4.5 eV-7 eV.

11. A method for producing hydrogen gas by a microwave plasma discharge, comprising:
a) maintaining an internal pressure of a dielectric hollow tube to a reduced pressure;
b) flowing a hydrogen-element containing gas from a gas supply source through the dielectric hollow tube;
c) subjecting the hydrogen-element containing gas to a microwave plasma discharge by applying a microwave to the dielectric hollow tube;
d) producing reaction products including hydrogen gas through intramolecular bond cleavage by collision of an electron produced by the microwave plasma discharge with the hydrogen element-containing gas; and
e) separating the hydrogen gas from the reaction products.

12. The method as set forth in claim 11, wherein the hydrogen-element containing gas is hydrocarbon that produces, as reaction products, hydrogen gas and solid carbon, and the solid carbon is recovered to a solid element storage installed below the dielectric hollow tube.
